(19) United States
(12) Patent Application Publication
(10) Pub. No.: US 2021/0354019 A1
(43) Pub. Date: Nov. 18, 2021

(54) MULTI-LAYER UNDERLAYMENT PAD FOR USE UNDER SPORTING SURFACES

(71) Applicant: TURF CUSHION INC, Dalton, GA (US)

(72) Inventor: John Karr, Ringgold, GA (US)

(21) Appl. No.: 15/931,638

(22) Filed: May 14, 2020

(51) Int. Cl. A63B 69/36; B32B 27/40; B32B 27/06; B32B 27/32; B32B 5/18

(52) U.S. Cl. CPC A63B 69/3661; B32B 27/40; B32B 5/18; B32B 27/32; B32B 27/065

(57) ABSTRACT

A multi-layer underlayment pad for use beneath activity surfaces such as artificial putting greens, such pad including a first foam layer comprising expanded polyethylene having a thickness ranging from about 0.25 inches to about 2 inches; and a second foam layer comprising polyurethane having a thickness ranging from about 0.125 inches to about 1 inch.

### FIELD

This disclosure relates to the field of padding layers for surfaces such as putting greens or other athletic surfaces.

### BACKGROUND

Padding used beneath activity surfaces such as putting greens and other activity surfaces are required to meet certain standards in order to be safe for people to use such activity surfaces. Different standard tests are available to test such padding to better ensure that such padding meets all such criteria. One such test is ASTM F1292-17 for playgrounds which involves both GMAX and Head Impact Criteria (HIC) categories. In order for a pad to pass this test for a specific drop height (height from which the head of a person could fall and hit the ground), the GMAX value must be less than 200 and the HIC value must be less than 1000. Therefore, the drop height determines how high playground equipment can be on a given playground. In order to pass these criteria for higher playground equipment, it is often necessary for manufacturers to make pads with greater thicknesses. Another test involving these criteria is ASTM F355 which is a standard test method for impact attenuation of playing surface systems and materials. In this case, too, often thicker padding is required for improved GMAX and HIC measured values. However, thicker padding is undesirable because it requires more material and more space beneath an activity surface such as a playground. Therefore, it is more expensive than if less material were used.

One disadvantage of artificial putting greens as compared to natural putting greens is the increased tendency for golf balls to bounce farther and longer after initial impact with an artificial putting green. This causes golf balls to more easily run off of a green after initial impact instead of experiencing a “grab” and a shorter second bounce, resulting in balls remaining on the green.

What is needed, therefore, is an underlayment pad for artificial putting surfaces that overcomes the drawbacks of conventional artificial putting surfaces.

### SUMMARY

A multi-layer underlayment pad is disclosed comprising a first foam layer comprising expanded polyethylene having a thickness ranging from about 0.25 inches to about 2 inches; and a second foam layer comprising polyurethane having a thickness ranging from about 0.125 inches to about 1 inch. The first foam layer is preferably a bottom layer and the second foam layer is preferably a top layer. The thickness of the first foam layer preferably ranges from about 0.6 inches to about 1 inch and the thickness of the second foam layer preferably ranges from about 0.125 inches to about 0.188 inches. The first foam layer preferably comprises a composition consisting essentially of expanded polyethylene. The second foam layer preferably comprises a composition consisting essentially of polyurethane. The first foam layer preferably has a density ranging from about 0.5 lb./ft³ to about 4 lb./ft³. More preferably, the first foam layer has a density ranging from about 1.1 lb./ft³ to about 1.45 lb./ft³.

The multilayer underlayment pad preferably includes a woven scrim backing layer located between the first foam layer and the second foam layer. The composition of the woven scrim backing layer preferably comprises polypropylene, phosphoenolpyruvate polymer, polyamide, acrylic polymer, or combinations thereof.

An artificial putting green is disclosed comprising a first foam layer comprising expanded polyethylene having a thickness ranging from about 0.25 inches to about 2 inches; a second foam layer above the first foam layer, the second foam layer comprising polyurethane having a thickness ranging from about 0.125 inches to about 1 inch; and an artificial turf layer above the second foam layer.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a drawing of an example of a multi-layer underlayment pad as disclosed herein;

FIG. 2 shows an image of a corner of the multi-layer underlayment pad from FIG. 1 showing tiered layers for illustrative purposes; and

FIG. 3 shows a drawing of an alternative multi-layer underlayment pad as disclosed herein.

The figures are provided to illustrate concepts of the invention disclosure and are not intended to embody all potential embodiments of the invention. Therefore, the figures are not intended to limit the scope of the invention disclosure in any way, a function which is reserved for the appended claims.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

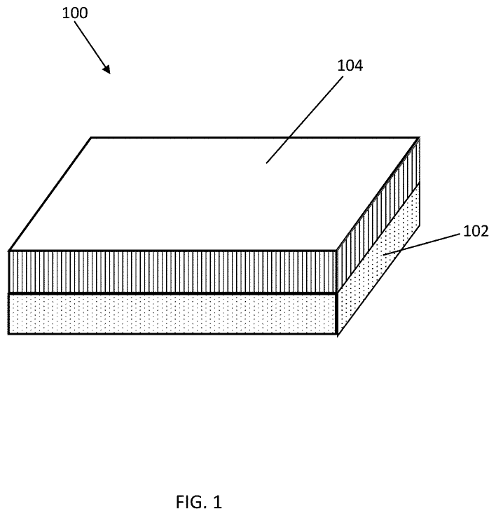

FIG. 1 shows a drawing of a multi-layer underlayment pad 100 as described herein. The pad includes a first foam layer 102 comprising expanded polyethylene having a thickness ranging from about 0.25 inches to about 2 inches; and a second foam layer 104 including polyurethane having a thickness ranging from about 0.125 inches to about 1 inch. In the preferred embodiment shown in FIG. 1, the first foam layer 102 is situated as a bottom layer and the second foam layer 104 is situated as a top layer. In a preferred embodiment, the thickness of the first foam layer 102 ranges from about 0.6 inches to about 1 inch and the thickness of the second foam layer 104 ranges from about 0.125 inches to about 0.188 inches. Preferably, the first foam layer 102 comprises a composition consisting essentially of expanded polyethylene.

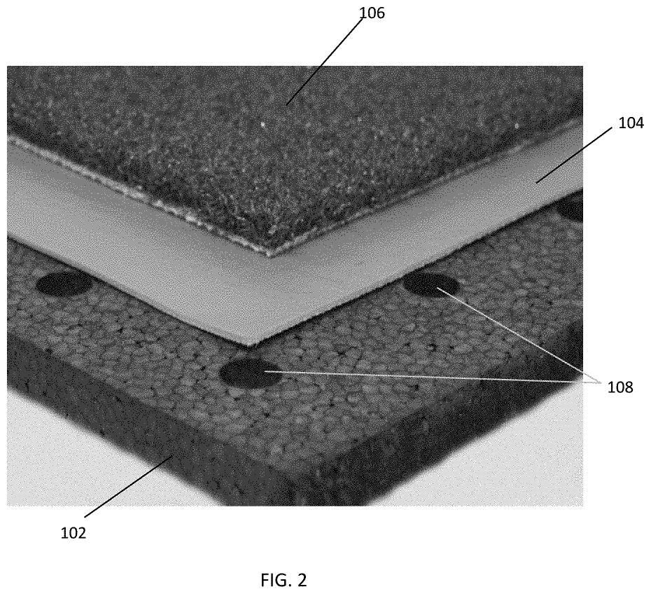

Preferably, the second foam layer 104 comprises a composition consisting essentially of polyurethane. “Consisting essentially of” as defined herein is intended to be at least 90% by weight, preferably 95% by weight, and most preferably 98% by weight. The first foam layer 102 preferably has a density ranging from about 0.5 lb./ft³ to about 4 lb./ft³. More preferably, the first foam layer 102 has a density ranging from about 1.1 lb./ft³ to about 1.45 lb./ft³. FIG. 2 shows an image of a corner of the multi-layer underlayment pad 100 including a turf layer 106 on top and a plurality of apertures 108 in the first foam layer 102 for water drainage.

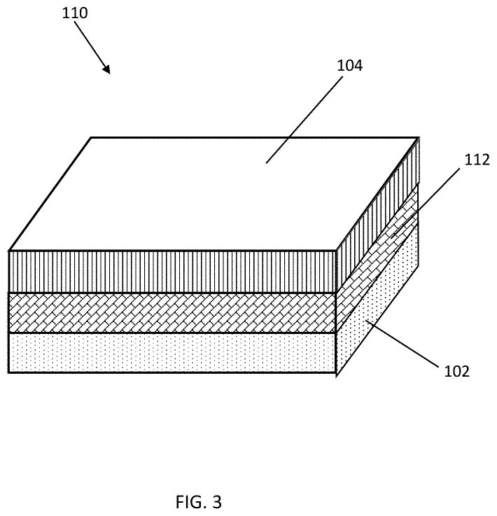

FIG. 3 shows a multilayer underlayment pad 110 including the first foam layer 102 and the second foam layer 104 and further including a woven scrim backing layer 112 located between the first foam layer 102 and the second foam layer 104. The composition of the woven scrim backing layer 112 preferably includes polypropylene, phosphoenolpyruvate polymer, polyamide, acrylic polymer, or combinations thereof.

The multilayer underlayment pad 100 and multilayer underlayment pad 106 can come in various sized including, for example and without limitation, 4 ft×6 ft, 2 ft×2 ft, 2 ft×4 ft, 5 ft×8 ft, and long rolls (e.g., 100 ft long). The first foam layer 102 preferably comes in 4 ft×6 ft pads. The second foam layer preferably comes in 6 ft×50 ft rolls.

A test installation was completed on a 6 ft×15 ft matrix of the multi-layer underlayment pad 100 under an artificial putting surface and over a flat and level concrete slab (Installation 1). The comparator was the same putting surface installed directly over the prepared crushed stone base (Installation 2). Five hundred test shots were made from three varied distances of 18 feet, 30 feet and 90 feet from the artificial putting surfaces. In sets of five balls each green, shots were made to the respective installations and measured from the point of impact to the ball position at rest. Attention was paid to the type of bounce, height of bounce, visible spin/“check”. Titleist Pro V balls were used for consistency. The data demonstrated that Installation 1 stopped the ball on average 10% faster than Installation 2 (in the same direction-down grain). The first bounce was generally straight and higher on Installation 1 with more grab on the ball in the first bounce as compared to Installation 2. Balls shot to Installation 2 bounced lower and slightly further with the second bounce showing the “grab”. Longer shots from 30 and 90 feet showed substantially higher first bounces on Installation 1 but suh balls also stopped on average about 10% faster. Some conclusions to be drawn from such experimentation is that the Installation 1 (including the multi-layer underlayment pad 100) absorbs the impact differently than Installation 2 and allows balls to drive deeper into the surface of Installation 1 where the spin has more surface area on which to grab. Additionally, Installation 1 provides more resilience or rebound and allows balls to jump higher off the initial bounce. The bounce with Installation 1 is more vertical than the flatter and longer distance bounce from Installation 2 thus creating a stopping advantage with Installation 1 including the multi-layer underlayment pad 100.

The multi-layer underlayment pad 100 was tested using ASTM F355 to test the shock absorbing properties of the underlayment pad 100 defining part of an activity surface. Above the pad 100 was a 3D blend of 52 ounce infilled turf at 1.9 pounds of sand per square foot and 1.9 pounds of rubber per square foot. A test specimen was impacted at a specified velocity with a 20 pound missile. A transducer mounted in the missile monitors the acceleration-time history of the impact, which is recorded with the aid of an oscilloscope or other recording device. The 20 pound missile included a 20 square inch surface area and the missile was dropped at an appropriate height to ensure the appropriate missile speed as specified by the ASTM method. All samples were loose laid on a four inch thick concrete slab. The GMAX values and Head Impact Criteria (HIC) were all recorded for three drops. The average GMAX value averaged between the second and third drops was 55. The average HIC value averaged between the second and third drops was 131. The reference point for HIC values is 1000, so the test results showed excellent HIC values. The turf was then tested by itself without the underlayment pad 100. The average GMAX value was 101 and the average HIC vale was 301. Use the underlayment pad therefore doubled the safety of the activity surface.

Compression recovery is also an important aspect for pads used under activity surfaces and the quantifiable level of resiliency is determined by measuring the thickness (or height) of a pad after it has been exposed to a load for a specific period of time. For example, if a two-inch-thick pad returns to a full two inches of thickness after testing within a specified period of time, the recovery would be considered 100% and the “loss” (hereinafter referred to as a “thickness loss”) would be considered 0%. If, on the other hand, the pad only returns to a thickness of 1.8 inches, the recovery would be considered 90% and the thickness loss would be considered 10%. The multi-layer underlayment pad 100 has demonstrated excellent compression recovery.

The first foam layer 102 may be manufactured to provide a wide variation of customized drainage capacity depending on the specific end user requirements. Customized drainage holes can be fabricated in a wide variety of shapes including circles, squares, stars, and other shapes using, for example, a hydraulic die press with a steel rule die to punch the holes or a CNC router to drill the holes. The drainage holes can be placed in a proper pattern such as, for example, 0.5-inch diameter holes spaced 15 inches apart and drilled using a four head Heian 431P 2613 CNC router machine that can be set up using 0.5-inch diameter drill bits in each of the four heads. The CNC machine can then be programmed to cut a specific pattern of holes. In certain applications other than putting greens, drainage rates for the multi-layer underlayment pad 100 of at least 35 gallons per square yard per hour (gal/yd²/hr.) and preferably greater than 45 gal/yd²/hr. can be achieved with certain configurations of drainage holes in the first foam layer 102. Drainage holes have diameters as large as up to about 0.75 inches.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible considering the above teachings. The embodiments are chosen and described to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A multi-layer underlayment pad comprising:
a. a first foam layer comprising expanded polyethylene having a thickness ranging from about 0.25 inches to about 2 inches;
b. a second foam layer comprising polyurethane having a thickness ranging from about 0.125 inches to about 1 inch; and
c. a woven scrim backing layer located between the first foam layer and the second foam layer.

2. The multi-layer underlayment pad of claim 1 consisting of the first foam layer as a bottom layer and the second foam layer as a top layer.

3. The multilayer underlayment pad of claim 1 wherein the thickness of the first foam layer ranges from about 0.6 inches to about 1 inch and the thickness of the second foam layer ranges from about 0.125 inches to about 0.188 inches.

4. The multilayer underlayment pad of claim 1 wherein the first foam layer comprises a composition consisting essentially of expanded polyethylene.

5. The multilayer underlayment pad of claim 1 wherein the second foam layer comprises a composition consisting essentially of polyurethane.

6. The multilayer underlayment pad of claim 1 wherein the first foam layer has a density ranging from about 0.5 lb./ft³ to about 4 lb./ft³.

7. The multilayer underlayment pad of claim 1 wherein the first foam layer has a density ranging from about 1.1 lb./ft³ to about 1.45 lb./ft³.

8. (canceled)

9. The multilayer underlayment pad of claim 1 wherein a composition of the woven scrim backing layer comprises a member selected from the group consisting of polypropylene, phosphoenolpyruvate polymer, polyamide, acrylic polymer, and combinations thereof.

10. An artificial putting green comprising:
a. a first foam layer comprising expanded polyethylene having a thickness ranging from about 0.25 inches to about 2 inches;
b. a second foam layer above the first foam layer, the second foam layer comprising polyurethane having a thickness ranging from about 0.125 inches to about 1 inch;
c. a woven scrim backing layer located between the first foam layer and the second foam layer; and
d. an artificial turf layer above the second foam layer.
